(19) United States
(12) Patent Application Publication
(10) Pub. No.: US 2012/0022886 A1
(43) Pub. Date: Jan. 26, 2012

(54) Medical Data Acquisition, Diagnostic and Communication System

(75) Inventor: Peter Ohnemus, Zug (CH)

(73) Assignee: Quentiq AG, Zurich (CH)

(21) Appl. No.: 13/182,408

(22) Filed: Jul. 13, 2011

Related U.S. Application Data
(60) Provisional application No. 61/363,886, filed on Jul. 13, 2010.

(51) Int. Cl. G06Q 50/24

(52) U.S. Cl. 705/2

(57) ABSTRACT

A system configured to collect biological samples using a sensor and to extract a medical parameter therefrom outputs a signal to a communication interface. The communication interface is configured to communicate with a wireless electronic communication device having a processor, a memory, and a display, for determination of a value representative of the sensed medical parameter and display on the display. The wireless electronic communication device is configured to transmit the signal to a remote computerized system that is configured to compare the signal to stored values in a database, and to provide a report comparing a value associated with the signal to the stored values.

### CROSS REFERENCE TO RELATED APPLICATION

The present application claims the benefit of U.S. patent application Ser. No. 61/363,886, filed Jul. 13, 2010, which is hereby incorporated by reference in its entirety.

### FIELD OF THE INVENTION

The present invention concerns the acquisition of medical data and its processing for diagnostic, benchmarking, analytics and redistribution purposes. More particularly, the invention concerns a system and method for acquisition, diagnosis, benchmarking, analytics and redistribution of medical data.

### BACKGROUND OF THE INVENTION

Despite advances in many areas of technology, there are still barriers to acquiring medical data and communicating it in a rapid, cost effective, and timely manner. With globalization, it is important to trace certain diseases faster, and this has not been adequately addressed in existing systems.

Among the various impediments attendant with known systems are the need to visit health care professionals, to provide samples, to undergo physical testing, to have samples and test results analyzed, and to coordinate that information between the medical professional, the patient, and any health organization (e.g., the World Health Organization).

The present invention addresses this problem by combining technologies in multiple disciplinary fields, and, in so doing, creates a minable data source that supports predictive medical indications of ailments, trends, and so on.

### SUMMARY OF THE INVENTION

In one exemplary aspect of the invention, a system for collecting, processing, and displaying medical data is provided. The system includes a sensor configured to collect biological samples and sense a medical parameter based on the collected biological sample. The sensor provides a signal that represents the sensed medical parameter. A communication interface is coupled to the sensor and configured to receive the signal from the sensor. The communication interface is further configured to transmit the signal. A wireless electronic communication device having a processor, a memory, and a display, the wireless electronic communication device is configured to wirelessly receive the signal from the communication interface, wherein the processor is configured to cause a value representative of the sensed medical parameter to be displayed on the display, and wherein the wireless electronic communication device is further configured to transmit the signal. The system further includes a database and a remote computerized system having configured to receive the signal from the wireless electronic communication device, compare the signal to stored values in the database, and provide a report comparing a value associated with the signal to the stored values.

In a more particular, optional arrangement, the report is viewable by an authorized group of persons.

In a further arrangement, the report is viewable through a portal that provides an interface to a global computer network.

According to a further optional arrangements, the stored values comprise values of previous medical parameters and the report indicates a trend be comparing the previous medical parameters to the sensed medical parameter based on the collected biological sample.

According to a further aspect of the invention, a method for collecting, processing, and displaying medical data, is provided. The method includes the step of collecting biological samples using a sensor, sensing a medical parameter based on the collected biological sample, and providing a signal that represents the sensed medical parameter to a communication interface coupled to the sensor. The method includes receiving the signal at a wireless electronic communication device having a processor, a memory, and a display. A value representative of the sensed medical parameter is caused to be displayed on the display. The signal from the wireless electronic communication device is transmitted to a remote computerized system. The signal is received at the remote computerized system. The signal is compared at the remote computerized system to values stored in a database. A report is provided that compares a value associated with the signal to the stored values.

Various features, aspects and advantages of the invention can be appreciated from the following Description of Certain Embodiments of the Invention and the accompanying Drawing Figures.

### DESCRIPTION OF THE DRAWING FIGURES

FIG. 1 is a schematic block diagram of a local medical data acquisition and communication system according to one embodiment of the invention; and

FIG. 2 is a schematic flow diagram according to one embodiment of the invention;

FIG. 3 is a schematic flow diagram according to an embodiment of the invention for data mining purposes.

### DETAILED DESCRIPTION OF CERTAIN EMBODIMENTS OF THE INVENTION

By way of overview and introduction, the present invention is described in detail in connection with a distributed system in which data acquisition, wireless communication, and data storage and mining are managed by components of an overall system as one specific implementation of a system and method in accordance with the invention. In a variation, as will be appreciated from the following description, data acquisition and wireless communication can be provided by a combined device that communicates with a remote, data storage and mining system.

In one embodiment, a system 100 includes a biosensor 110 coupled to a microcontroller 120 by way of a biosensor interface 115. The microcontroller includes a processor, a memory and code executing thereon so as to configure the processor to perform the functionality described herein. The memory is for storing data and instructions suitable for controlling the operation of the processor. An implementation of memory could include a random access memory (RAM), a hard drive and a read only memory (ROM). One of the components stored in memory is a program. The program includes instructions for controlling the processor to execute the methods described herein. The program can be implemented as a single module or as a plurality of modules that operate in cooperation with one another. The program is contemplated as representing a software component that is used in connection with an embodiment of the method described hereinabove.

The components of the system 100 that are used by and located near the patient preferably include a fingerprint reader, password, keyfob, encryption or other mechanism to ensure that the device is secure. A speech or voice recognition system can be utilized for elderly, handicapped or users that lack experience, skill or ability to utilize the system. In one implementation, this part of the system 100 is a stand-alone or portable device that does on-the-spot analysis of the measured biosensed data. For instance, a kiosk or other station can be provided in a retail establishment or elsewhere at which a person can have their metrics sensed and sampled and communicated to the central data storage.

The biosensor interface 115 converts biological signals coupled by the biosensor 110 into a form that can be processed by the microcontroller. The biosensor interface can include several interfaces depending on the nature of the biosensor. Biosensors of various types are known for providing a biological or chemical assessment of a blood sample or components of the blood (e.g., platelets, hemoglobin, etc.), hair, urine, sweat, breath, and so on. Some biosensors can comprise microneedles that break through the epidermis, capture a blood sample, and utilize chemical/biological agents to identify the presence or absence of chemicals, elements, pH, microfluids (that is, fluids containing synthetically created nanosparticles), and a myriad other values associated with the test being performed using the biosensor (e.g, cholesterol levels, blood sugar levels, vitamin levels, hormone levels, etc.). Other biosensors can be in contact with skin, or be implanted below the dermis, or other parts of the body (e.g., the ear), or can be oriented toward a body feature (e.g., the eye or nasal cavity). Regardless of its form, the biosensor 110 measures clinically relevant values that can be used to detect, diagnosis, monitor or demonstrate control over bodily function or surrogates thereof that is causing or may later cause symptoms. The measurements can include heart rate, blood pressure, oxygen values, muscle tension, respiration, body temperature, and so on.

The system 100 can include an application programming interface (API) to the microcontroller to enable partners to build biosensor devices and peripheral applications that can communicate with the microcontroller and provide post-processing data to the data center, discussed below.

The biosensor delivers information to the system 100 via the biosensor interface 115. The biosensor interface 115 is in communication with an output of the biosensor, whether that is a signal (e.g., an optical signal or electrical signal indicating a sense biological parameter (e.g. blood glucose, etc.)) or a chemical/biologic sample. The biosensor interface operates to provide data a micro-laboratory for the purpose of reducing the sensed biological information to a manageable data set suitable for wireless transmission, as described below.

A communication subsystem 125 is provided for communicating information from the controller 120 to another device, such as an external device (e.g., handheld unit or a computer that is connected over a network to the communication subsystem 125). Information can be communicated by the communication subsystem 125 in a variety of ways including Bluetooth, WiFi, WiMax, RF transmission, and so on. A number of different network topologies can be utilized in a conventional manner, such as wired, optical, 3G, 4G networks, and so on.

The communication subsystem can be part of a communicative electronic device including, by way of example, a smart phone or cellular telephone, a personal digital assistant (PDA), netbook, laptop computer, and so on. For instance, the communication subsystem 125 can be directly connected through an iPhone, Google Phone, BlackBerry, Microsoft Windows Mobile enabled phone, and so on, any of which comprises an external device in communication with the subsystem 125 to allow information and control signals to flow between the subsystem 125 and the external device 130. The external device can be a electronic communication device, such as a smart phone, for example. In short, the communication sub-system can cooperate with a conventional communicative device, or can be part of a device that is dedicated to the purpose of communicating information processed by the microcontroller 120.

Optionally, the information obtained by the system 100 can be displayed or transmitted for display immediately to the patient and or others, including physicians and/or managed-care organizations, to demonstrate effectiveness and or progress of any therapy or changes dues to stresses of work, sport, training, and so on. When a communicative electronic device such as the types noted above are used as an external device 130, the display and memory of such devices can be used to provide the medical data to the patient and to others nearby. Otherwise, the system 100 can include a display 140 and a memory 150 that are associated with the external device and used to support data communication in real-time or otherwise. More generally, the system 100 includes a user interface which can be implemented, in part, but modules executing in the processor of the microcontroller 120 or under control of the external device 130. In part, the user interface can also include an output device such as a display (e.g., the display 140). For example, the sensor can generate a signal indicative of a parameter that the sensed biological material processes. The signal can be communicated to the wireless electronic device and displayed on the display in a manner that informs the user/physical of the measured medical parameter. As one illustrative example, the sensor can measure a person's blood to determine a medical parameter (e.g. blood glucose) and the sensor generates a signal based on the sensed blood and the signal can be received by the external device and displayed on the device in manner that indicates the person's blood glucose level.

It will be understood that the interface should include signal transmission that is appropriate to Health Maintenance Organizations, Insurance Companies, and or Managed Care companies, as well as patients and physicians already described. In this manner, information can be readily transmitted from the microcontroller to a person at a remote location via the use of the subsystem 125 or an external communications device 130. A physician or the like can thus monitor, over an external device 130, the measurements (bio-properties) taken at the biosensor and communicated by the microcontroller 120.

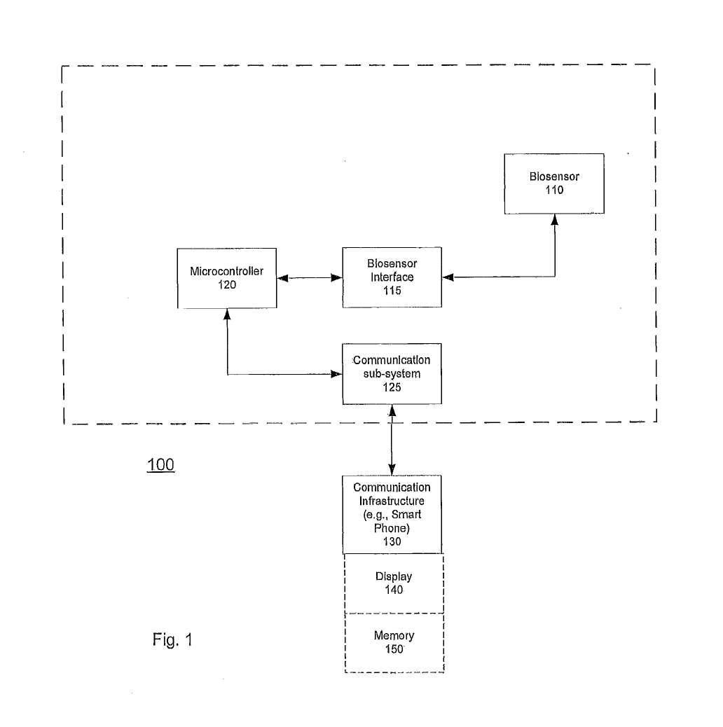

Not shown in FIG. 1 is the power source (e.g., the battery) that powers the illustrated components and any other electronic components that require power.

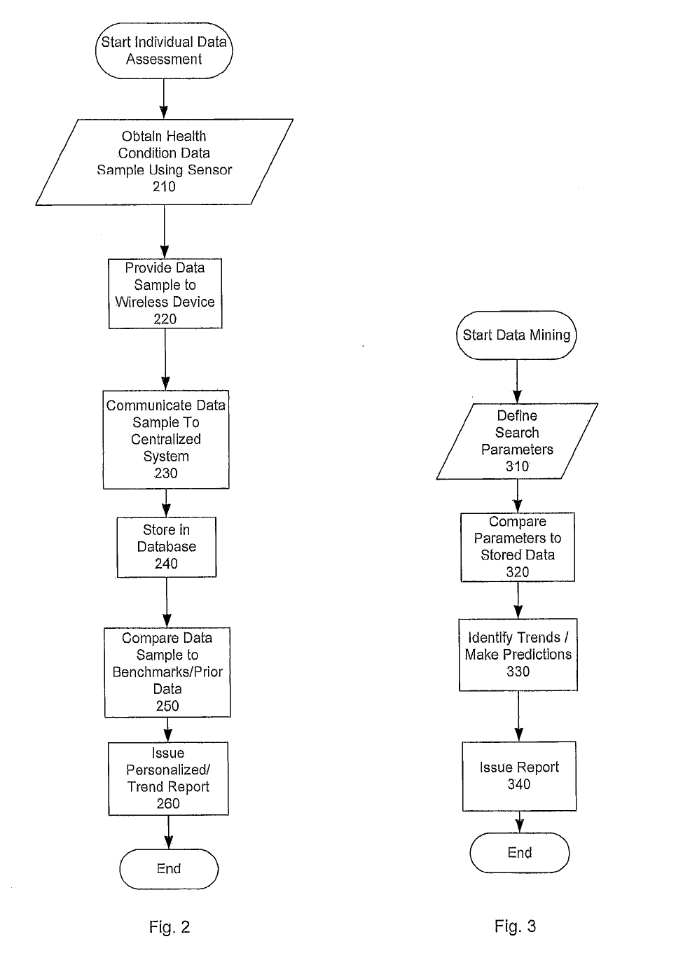

Referring now to FIG. 2, a schematic flow diagram according to one embodiment of the invention is described in support of an assessment of a person (e.g., a patient). At step 210, health condition data concerning the person is obtained using a sensor such as the biosensor 110 described above. The data sample so-obtained is processed within the microcontroller and sample data that is a post-processed, transformed version of the obtained data sample is provided to a wireless device, at step 220, such as by way of a communication subsystem 125 to an external device 130 using any standard data protocol, preferably with encryption or encoding to protect the identity of the person. In this regard, the person can identify himself with an ID number (anonymous) rather than using his or her name Alternatively, and in a more particular embodiment, a fingerprint reader can be configured to acquire an image of the person's fingerprint while concurrently obtaining a blood, skin, or sweat sample by having the sample-obtaining mechanism co-located in the vicinity of the fingerprint acquisition device. For example, a needle seated alongside or within a platen that is adapted using reflected light and an image sensor array can capture a fingerprint while the adjacent mechanism obtains the sample. The external device 130 communicates the data to a centralized system at step 230, which can be located remote from the person, anywhere on the globe. The communicated data is stored at step 240 within a global database, such as a data center in communication with servers and further laboratory devices. The transfer can be to a centralized PC/server that is connected to a laboratory/computer system, or to a data storage device, or to the centralized laboratory system itself. Such transfers can be in near real time (20-30 minutes), close to real time (5-20 minutes) or, with more powerful systems, in real time.

The stored data is subject to testing for a health condition of the person. This is true regardless of whether the obtained sample was obtained from blood, urine, hair, breath samples, and so on. At step 250, the processed and communicated sample data is compared to data in a data store. The data in the data store can comprise prior data of the person to provide an indication of any change in measured value from one or more prior measurement times. The data in the data store can comprise data obtained from a multiplicity of other people, including filtered sets of people such as persons of the same gender, age or age range, demographic profile, geographic proximity, place of birth, common ancestry, common medical history, and so on.

At step 260, the process produces a report that identifies personal issues and/or trends that can be discerned as a result of the testing and data analysis described just previously.

As data is communicated to the data center from a multiplicity of persons, the system 100 will have and or combine with other data sources to have medical information on millions of people, which data is susceptible to licensing or mining by interested parties, including by way of example and not limitation, pharmaceuticals companies, vitamin suppliers, investigators, and health organizations. The data set continues to grow and become more reliable as time goes by, to provide health and recovery data for mining by external systems through a portal such as may be provided by an interface to a global computer network.

Turning now to FIG. 3, a data mining method has a user defining search parameters at step 310. The search parameters can be input into a form and submitted to the portal, pushed to the portal from a file, or generated automatically by an algorithm that executes to discover trends or relationships among the stored data. At step 320, the search parameters—no matter how defined—are compared to the data in the central data store. As a result of the comparison, trends can be identified, if they exist, or predictions as to a person's or target-group of people's health can be made, as indicated at step 330. Reports are then issued (i.e., distributed) through the portal, as indicated at step 340, to persons authorized to have such data, and the data being distributed can be without any information that identifies any of the individuals whose data is included among the distributed information. A report can be displayed as information on a webpage, for example.

The portal provides indications and/or analytics to the user or medical practitioner of health related data. As non-limiting examples, the indications can include, among others: acid in the blood, glucose, indication of prostate cancer, prostate number, any cancer indication, any bacteria, testosterone, estrogen, alcohol (detecting young people, employees or drivers of automobiles), general blood values (plasma, red and white blood cells etc), HIV, herpes, hepatitis, syphilis (this could be used for a very low cost indication of diseases in urban areas and/or emerging economies), and oxygen in the blood (sports people who want to test their overall blood oxygen and lung capacity). Parents, partners, employers or sports people can be tested for real time doping, drug use, protein levels, nicotine levels, lactic acid, and so on. Additionally to that, the portal could provide information on blood sugar for people having blood sugar problems related to insulin. As non-limiting examples, the analytics can include a myriad of statistical data derived from anonymous data, such as, among others, the average iron level of ladies over 50 years of age, or the C vitamin average level of a man between 40 and 50 years of age.

The system could also analyze and provide indication of vitamins and other minerals in the blood supporting indication of vitamins such as A, B, B2, B3 C, D, E, calcium, copper, zinc, magnesium, iron, phosphor etc.

One example application is a real-time adrenaline check of a person playing a computer game. Another example application is a global epidemic detection in which acquired data from persons are tracked and patterns identified quickly and cost effectively. The detection system can help people stay in top training or just support parents in looking after their kids (drug abuse), employees testing (alcohol or drug abuse) or simply people that are looking for a way to support so-called “active aging.” A different application can be to identify persons who, on the basis of at least the obtained data samples, are predicted as making good partners (e.g., in view of their respective blood types), or that might be attracted to one another based on body chemistry and such.

The advantage of the system is that it would provide sports people with benchmarking capabilities, it will supply parents control, it could promote save driving, it could prevent health care fraud, would support the lack of doctors that we will have in the Western world for doing first level checks (the demographics of the Western world will lead to 40-65% being over 65 over the coming 30 years).

The methods described herein have been described in connection with flow diagrams that facilitate a description of the principal processes; however, certain blocks can be invoked in an arbitrary order, such as when the events drive the program flow such as in an object-oriented program implementation. Accordingly, the flow diagrams are to be understood as example flows such that the blocks can be invoked in a different order than as illustrated.

While the invention has been described in connection with certain embodiments thereof, the invention is not limited to the described embodiments but rather is more broadly defined by the recitations in any claims that follow and equivalents thereof.

1. A system for collecting, processing, and displaying medical data, comprising:
a sensor configured to collect biological samples, sense a medical parameter based on the collected biological sample, and provide a signal that represents the sensed medical parameter;
a communication interface coupled to the sensor and configured to receive the signal from the sensor and communicate the signal;
a wireless electronic communication device having a processor, a memory, and a display, the wireless electronic communication device is configured to wirelessly receive the signal from the communication interface, wherein the processor is configured to cause a value representative of the sensed medical parameter to be displayed on the display, and wherein the wireless electronic communication device is further configured to transmit the signal;
a database;
a remote computerized system having configured to receive the signal from the wireless electronic communication device, compare the signal to stored values in the database, and provide a report comparing a value associated with the signal to the stored values.

2. The system of claim 1, wherein the report is viewable by an authorized group of persons.

3. The system of claim 1, wherein the report is viewable through a portal that provides an interface to a global computer network.

4. The system of claim 1, wherein the report is viewable through a portal that provides an interface to a global computer network.

5. The system of claim 1, wherein the stored values comprise values of previous medical parameters and the report indicates a trend be comparing the previous medical parameters to the sensed medical parameter based on the collected biological sample.

6. A method for collecting, processing, and displaying medical data, comprising:
collecting biological samples using a sensor,
sensing a medical parameter based on the collected biological sample,
providing a signal that represents the sensed medical parameter to a communication interface coupled to the sensor;
receiving the signal at a wireless electronic communication device having a processor, a memory, and a display,
causing a value representative of the sensed medical parameter to be displayed on the display,
transmitting the signal from the wireless electronic communication device to a remote computerized system;
receiving the signal at the remote computerized system;
comparing the signal at the remote computerized system to values stored in a database, and
providing a report that compares a value associated with the signal to the stored values.
